(19) United States
(12) Patent Application Publication
(10) Pub. No.: US 2011/0014872 A1
(43) Pub. Date: Jan. 20, 2011

(54) Apparatus for communicating signals

(76) Inventor: Gary Wayne Langham, Canton, MS (US)

Correspondence Address: THE MATTHEWS FIRM, 2000 BERING DRIVE, SUITE 700, HOUSTON, TX, 77057, US

(21) Appl. No.: 12/460,296

(22) Filed: Jul. 16, 2009

(51) Int. Cl. H04B 7/00

(52) U.S. Cl. 455/41.3

(57) ABSTRACT

An apparatus for use communicating signals from a first device to a second device is disclosed herein, the apparatus including a receiver and circuitry disposed within a housing. The receiver is configured to receive a wireless signal from a first device, the circuitry causing playback of the wireless signal using the second device. Optionally, the apparatus can include a microphone for receiving voice input and a transmitter for transmitting the voice input to the first device for further transmission.

### FIELD

The present invention relates, generally, to an apparatus for use communicating signals from a first device to a second device, and more specifically, to an apparatus usable to receive audio signals from a wireless device and communicate the audio signals to a vehicle-based audio system or other non-portable audio system for playback.

### BACKGROUND

Most portable wireless devices are capable of playing and/or streaming music and other audio files, including voice communications. Such devices include, without limitation, cellular telephones, portable computers, portable music players, and other similar devices. Many vehicles possess auxiliary ports, or other ports and/or connectors, usable to engage a portable device with the vehicle's stereo system, enabling the audio files to be played using the vehicle's stereo speakers while driving, in lieu of, or in addition to, any headphones, integrated speakers, or other speakers associated with the portable device. Additionally, various other indoor stereo systems and other devices have auxiliary ports usable for a similar purpose.

While selected portable music players, such as the I-Pod® and similar devices, are configured to directly engage the auxiliary port of a vehicle-based stereo system, or other sound system having an auxiliary port, some portable music players, as well as other portable wireless devices capable of playing audio files, such as cellular telephones, lack such functionality. These devices are normally restricted to playing audio files using integrated speakers or headphones.

Modern, state-of-the-art cellular telephones and other wireless devices, are often provided with Bluetooth™ capabilities, which enable different types of wireless devices to exchange data seamlessly, as if connected by cables or other direct means. Similarly, many state-of-the-art vehicles have Bluetooth™ receivers built therein, enabling vehicle occupants with suitable cellular telephones and other wireless devices to interface such devices with their vehicle, thereby enabling use of the vehicle's stereo system to provide voice output from telephone calls as well as other audio files. Such systems are of particular use in states and municipalities where use of a cellular telephone while driving is prohibited if one of the driver's hands are occupied by the telephone, i.e. regions that require use of “hands-free” devices.

The large majority of owned vehicles, however, lack the built-in functionality to interface with a cellular telephone. As an alternative, some vehicles can have communication systems, such as OnStar™, preinstalled or installed as an after-market addition. However, such systems function as discrete vehicle-based telephones rather than serving as interfaces for existing cellular telephones. Other alternatives include discrete Bluetooth™ receivers, which can be transported within a vehicle, such as through attachment to a vehicle's sun visor, for receiving signals from a driver's cellular telephone and playing such signals through integrated speakers. FM transmitters are also usable, which receive wireless signals from portable devices, then transmit these signals over an unused FM frequency on a vehicle's stereo system to enable playback of the signals using the vehicle's stereo speakers. However, FM transmitters often suffer from interference and signal loss, providing poor quality sound.

A need exists for an apparatus usable after-market, to directly engage a vehicle-based stereo system, or other non-portable sound system, such as by using an auxiliary port, that receives wireless audio signals for playback using the stereo speakers.

A further need exists for an apparatus usable to receive audio signals, including music and voice signals, from a large variety of portable wireless devices, including cellular telephones, portable computers, portable music devices, and similar devices, and to transmit voice input to a wireless device for further transmission.

A need also exists for an apparatus able to transmit wireless audio signals to selected audio devices that is removable, compact, and able to be selectively transported between differing vehicles or other audio devices.

The present invention meets these needs.

### SUMMARY

The present invention relates, generally, to an apparatus for use communicating signals from a first device to a second device. In a preferred embodiment of the invention, the apparatus is usable to receive wireless audio signals from a portable wireless device, such as a cellular telephone, a portable computer, a portable audio/music player or other audio device, other similar devices, or combinations thereof, and to communicate wireless audio signals from this device to a vehicle-based audio system or other non-portable audio system. In an alternate embodiment of the invention, the apparatus can be used to receive wireless video signals and communicate these signals to a non-portable system having both audio and video output devices.

The apparatus includes a housing configured to removably engage the second device, such as through engagement with an auxiliary port of a vehicle-based audio system, or other audio system having an auxiliary port. While the housing can have any shape or dimensions, in various embodiments of the invention, the housing can be generally cylindrical or generally rectangular, having a compact design to accommodate engagement within vehicles and outer audio systems having limited space. The housing can include a standard ⅛″ jack, such as those common to various types of headphones and similar devices, typically usable for engagement with an auxiliary port of a vehicle stereo system. The jack or similar connecting member can be offset from the center of the housing to enable multiple arrangements of the housing, depending on the available space for engagement with a vehicle or other audio device.

A receiver is disposed within the housing, the receiver being configured to receive a wireless signal from the first device. The receiver can include any type of wireless receiver, including Bluetooth™ capable receivers able to interface with a large variety of wireless devices. Corresponding circuitry is also disposed within the housing, in communication with the receiver and the second device, the circuitry being configured to cause playback of the wireless signal from the first device using the second device. For example, in an embodiment of the invention, the apparatus can be engaged with the auxiliary port of a vehicle-based stereo system, and provided with wireless communication with a cellular telephone. The cellular telephone can then wirelessly transmit an audio signal, such as music or voice data, to the device, where the circuitry causes the audio signal to be played using the speakers of the vehicle-based stereo system.

In a preferred embodiment of the invention, the apparatus can also include a microphone, usable to receive voice input from a user, and a transmitter in communication with the microphone and the first device, the transmitter being configured to communicate the voice input to the first device for further transmission. For example, the apparatus can be used to cause voice data from an incoming cellular telephone call to be played using a vehicle's stereo speakers, in the manner described previously, and a user can then speak such that the user's voice is received by the microphone. The apparatus would then wirelessly transmit the user's voice to the cellular telephone, for further wireless transmission via the cellular network.

The apparatus can also be provided with voice recognition software, enabling the microphone to be used to receive voice inputs to dial a cellular telephone, or to otherwise control and/or manipulate the apparatus and/or any wireless devices in communication with the apparatus. The apparatus can further be provided with the ability to audibly communicate the nature and/or identity of incoming telephone calls, such that a user can selectively decide to use manual or voice commands to answer a telephone call without diverting his or her visual attention from the road to the apparatus or to the cellular telephone.

In various embodiments of the invention, the circuitry of the apparatus can include a processor in communication with computer instructions usable to convert the wireless audio signal from the first device, and/or voice input from the microphone, to a format receivable and/or usable by the receiving device. The circuitry can also possess the ability to receive video signals and computer instructions for converting and/or manipulating video signals for communication to a video playback device.

In a further embodiment of the invention, the circuitry can be adapted to automatically cease playback of a first wireless signal when a second wireless signal is received. For example, a music file can be transmitted from a portable music player to the apparatus for playback using the stereo speakers of an audio system, as described previously, until a cellular telephone, also in communication with the apparatus, receives an incoming call. At that time, the circuitry of the present apparatus can automatically cease playing the music file and begin communicating the received voice data from the cellular telephone using the stereo speakers. Similarly, receipt of a second signal from the same device can also cause playback of the first signal to cease.

The apparatus can also include one or more input members usable to control various functions of the apparatus, such as providing power to the apparatus, controlling the volume of the sounds provided, and/or establishing recognition between the apparatus and wireless deice, such as through use of Bluetooth™ pairing. Input members can also be used to cause playback of the wireless signal using the second device and/or to cease playback of the wireless audio to enable transmission of voice input, such as by enabling selective discontinuing of a music file to enable use of the microphone to conduct a telephone call.

In operation, an embodiment of the present apparatus can be provided in communication with an audio device, such as through engagement with an auxiliary port of a vehicle-based stereo system, or similar non-portable audio system. A wireless device, such as a cellular telephone, can be placed in communication with the apparatus, such as through Bluetooth™ paring or similar means, and the apparatus can be used to receive a wireless audio signal from the wireless device. If necessary, the apparatus can transform and/or convert the wireless audio signal. The signal is then communicated to the audio device for playback.

Playback of the wireless signal can be selectively or automatically stopped when a second wireless signal, such as a telephone call, is received by the wireless device, or when a user wishes to make an outgoing telephone call or provide other voice input to the apparatus.

Embodiments of the present invention thereby provide a compact and versatile apparatus usable as an after-market addition to directly and removably engage a non-portable audio system and/or video system, to receive audio and/or video signals from a large variety of wireless devices, and to selectively and/or automatically cause playback of the signals using the non-portable system.

### BRIEF DESCRIPTION OF THE DRAWINGS

In the detailed description of various embodiments of the present invention presented below, reference is made to the accompanying drawings, in which:

FIG. 1A depicts a front perspective view of an embodiment of the present apparatus.

FIG. 1B depicts an alternate front perspective view of the apparatus of FIG. 1A.

FIG. 1C depicts a left side view of the apparatus of FIG. 1A.

FIG. 1D depicts a right side view of the apparatus of FIG. 1A.

FIG. 2A depicts a front perspective view of an alternate embodiment of the present apparatus.

FIG. 2B depicts an alternate front perspective view of the apparatus of FIG. 2A.

FIG. 2C depicts a left side view of the apparatus of FIG. 2A.

FIG. 2D depicts a right side view of the apparatus of FIG. 2A.

FIG. 3 depicts a diagram of an embodiment of the present apparatus.

Embodiments of the present invention are described below with reference to the listed Figures.

### DETAILED DESCRIPTION OF THE EMBODIMENTS

Before explaining selected embodiments of the present invention in detail, it is to be understood that the present invention is not limited to the particular embodiments described herein and that the present invention can be practiced or carried out in various ways.

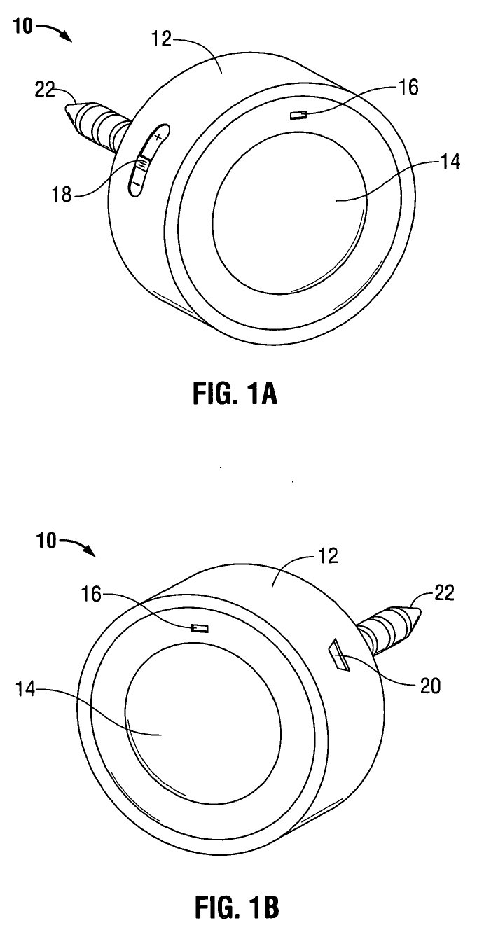

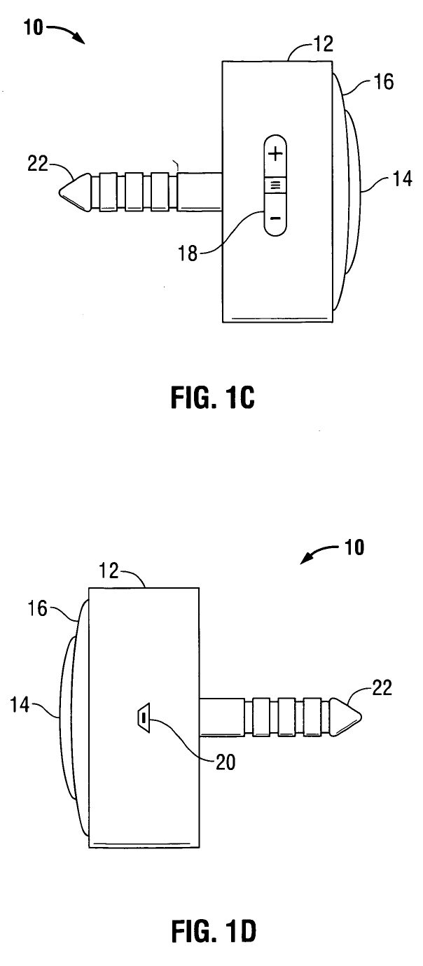

FIGS. 1A and 1B depict front perspective views of an embodiment of the present apparatus. FIGS. 1C and 1D depict opposing side views of the apparatus. The apparatus (10) is shown having a housing (12), which is depicted as having a generally cylindrical shape with a diameter of about 1.25 inches and a height of about 2 inches, however it should be understood that other dimensions and shapes are also usable within the scope of the present invention. The housing (12) can be formed from any durable material including plastic, metal, wood, rubber, one or more polymers, or other similar materials able to retain their shape. The housing (12) can include circuitry, a receiver and/or transmitter, a power source, such as one or more rechargeable batteries, and other similar components. The housing (12) is shown having an input member (14), depicted as a button, disposed on its front, usable to control power to the apparatus (10) and/or control the signals output by the apparatus (10). Other types of input members, including switches, knobs, dials, or other types of selectors or other devices able to provide input to the apparatus (10) are also usable.

The input member (14) can be used to control multiple functions of the apparatus (10). For example, in an exemplary embodiment of the invention, the input member (14) can be held for one second to activate and deactivate power to the apparatus (10), and can be held for three seconds to engage Bluetooth™ paring mode between the apparatus (10) and a wireless device. When communicating with a cellular telephone, the input member (14) can also be pressed to answer incoming telephone calls, to initiate outgoing telephone calls, and to disconnect ongoing telephone calls.

In a further embodiment of the invention, the input member (14) can be integral with a LED or similar indicator, or an indicator can be disposed elsewhere on the housing (12). The indicator can be used to communicate various aspects of the status of the apparatus (10). For example, an indicator disposed on or behind the input member (14) could provide a blue light when power is supplied to the apparatus (10), a red light when the power source of the apparatus (10) is being charged, and a flashing red light when the power source of the apparatus (10) is nearing full discharge.

FIGS. 1A and 1B further show the apparatus (10) having a microphone (16) disposed therein. While any microphone or similar device able to receive voice input is usable within the scope of the present invention, in an embodiment of the invention, the microphone (16) can include a multi-directional microphone with noise cancellation features. Voice input received by the microphone (16) can be transmitted wirelessly to a portable device in wireless communication with the apparatus (10) and/or to a device engaged directly with the apparatus (10).

The apparatus (10) is also shown having a volume control (18), usable to control the volume of the sound transmitted by the apparatus (10). In various embodiments of the invention, the apparatus (10) can also include controls for adjusting the sensitivity of the microphone (16), and/or separate volume controls for adjusting sounds output to differing devices. For example, the apparatus (10) could receive a wireless audio signal and transmit the signal to a non-portable device at a first volume, and could receive voice input via the microphone (16) and transmit the voice input to a portable device at a second volume.

FIGS. 1B and 1D further depict the apparatus (10) including a charging port (20) for providing power to the power source of the apparatus (10). The charging port (20) is shown as a micro USB charging port, however any type of charging mechanism able to interface with a rechargeable power source can be usable within the scope of the invention. Further, in various embodiments of the invention, the charging port (20) can be omitted, the apparatus (10) operating using replaceable power sources, a direct connection to a vehicle-based power source or other power source, or combinations thereof.

The housing (12) of the apparatus (10), as shown in FIGS. 1C and 1D, is depicted having an engagement member (22), which is depicted as a standard ⅛″ jack for use with headphones and/or auxiliary ports. Other types of engagement members (22) are also usable, depending on the nature of the device to which the apparatus (10) is to be engaged. Embodiments of the invention can include multiple and/or interchangeable engagement members for engagement with differing types of devices. Further, the position of the engagement member (22) on the housing (12) can vary depending on the configuration of the system to be engaged and the available space for engagement. For example, in the depicted embodiment of the invention, the engagement member (22) is shown disposed generally centrally along the housing, however in alternate embodiments of the invention, the engagement member (22) can be disposed offset from the center of the housing to enable use of the apparatus (10) within vehicles and other systems having small areas for accommodating the apparatus (10).

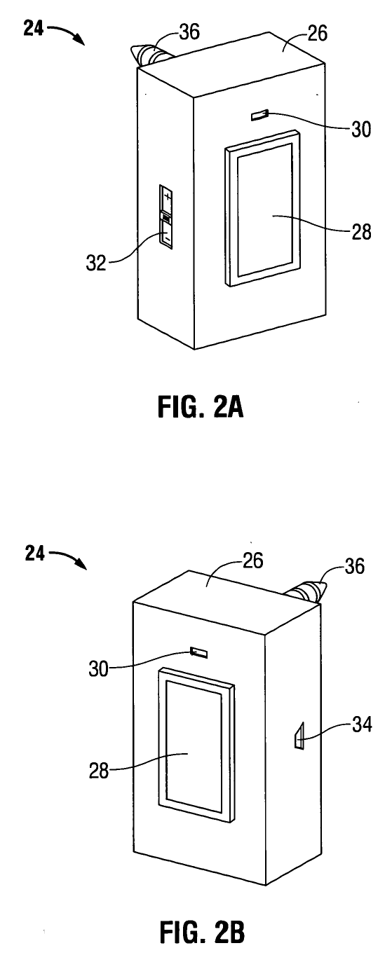

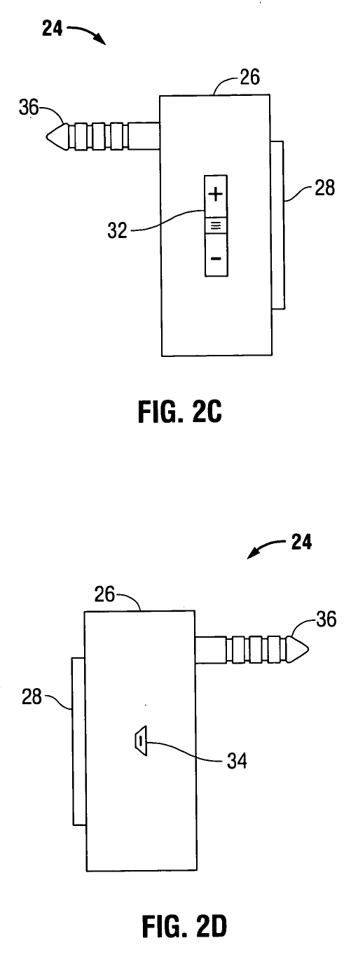

FIGS. 2A and 2B depict front perspective views of an alternate embodiment of the present apparatus. FIGS. 2C and 2D depict opposing side views of this embodiment of the apparatus. The depicted embodiment of the apparatus (24) is shown having a rectangular housing (26), depicted with a height of 1.5 inches, a width of 1.0 inches, and a depth of 0.75 inches. It should be noted that the depicted embodiments of the rectangular housing (26), and the cylindrical housing (12, depicted in FIG. 1) are exemplary embodiments, and that the housing of the apparatus can have any shape or dimensions as desired.

The rectangular housing (26) can include circuitry, a receiver and/or transmitter, a power source, and/or other similar components, as described previously. The rectangular housing (26) is shown having an input member (28), depicted as a button disposed thereon, usable to control power and/or a variety of functions in the manner described previously. Further, the input member (28) can be integral with or otherwise in communication with an LED or similar indicator, as described above.

With regard to FIGS. 2A and 2B, the apparatus (24) is further shown having a microphone (30) disposed therein, which can be any type of microphone or other device able to receive voice input, as described previously. The apparatus (24) is also shown having a volume control (32), depicted in FIGS. 2A and 2C, usable to control the volume of the sound transmitted by the apparatus (24) to any directly or wirelessly engaged devices, and/or to control the sensitivity of the microphone (30). The apparatus (24) is additionally shown including a charging port (34) for providing power to the power source of the apparatus (24), as depicted in FIGS. 2B and 2D.

FIGS. 2C and 2D depict the rectangular housing (26) is having an engagement member (36), which is shown as a standard ⅛″ jack, as described previously, off-set from the center of the rectangular housing (26) to enable the apparatus (10) to be accommodated in a variety of orientations and spaces.

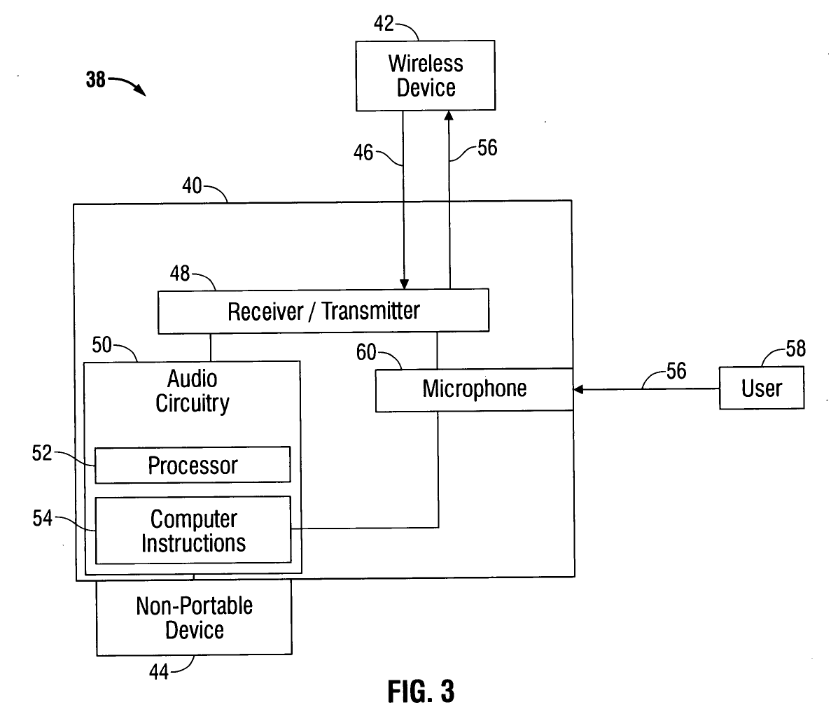

Referring now to FIG. 3, a diagram of an embodiment of the present apparatus is shown. Specifically, the apparatus (38) is depicted having a housing (40) containing numerous internal components. The apparatus (38) is shown in wireless engagement with a wireless device (42), and in direct engagement with a non-portable device (44), for the purpose of communicating signals therebetween.

The wireless device (42) is shown transmitting a wireless signal (46), which can include a music file, a video file, voice data, or similar information, to the apparatus (38), where the wireless signal (46) is received by a receiver/transmitter (48) disposed within the housing (40). While FIG. 3 depicts the receiver/transmitter (48) as a single element, it should be understood that the apparatus (38) can include any number of separate or integrated receiver and transmitter devices. The receiver/transmitter (48) is shown in communication with audio circuitry (50). The audio circuitry (50) is depicted including a processor (52) in communication with computer instructions (54), which can be stored in any integral, remote and/or removeable data storage media or other form of memory in communication with the audio circuitry (50), the computer instructions (54) being usable to instruct the processor (52) to communicate the wireless signal (46) to the non-portable device (44). In various embodiments of the invention, the computer instructions (54) can cause the processor (52) to convert the wireless signal (46) to a format receivable and/or usable by the non-portable device (44). In such embodiments of the invention, the audio circuitry (50) can include devices and/or circuitry necessary for various conversions, such as an analog to digital converter, or various other devices.

FIG. 3 also depicts voice input (56) provided by a user (58) into a microphone (60) disposed within the housing (40), in communication with the receiver/transmitter (48) and the audio circuitry (50). The audio circuitry (50) can cause the voice input (56) to be transmitted by the receiver/transmitter (48) to the wireless device (42), and in various embodiments of the invention, the voice input (56) can first be converted to a format receivable/usable by the wireless device (42).

In a further embodiment of the invention, the computer instructions (54) can cause the processor (52) to stop communication of the wireless signal (46) when another wireless signal is received, or when voice input (56) is received. Similarly, the computer instructions (54) can cause the processor (52) to selectively receive the wireless signal (46), voice input (56), or combinations thereof through received inputs from an input member (not shown), such as a button, switch, or other selector. Additionally, the computer instructions (54) can cause the processor (52) to selectively control the volume of either of the wireless signal (46) and/or the voice input (56), to activate and manipulate one or more display elements, such as LED devices, to indicate various states and/or conditions of the apparatus (38).

The present invention thereby provides a compact, removable apparatus, usable after-market, to directly engage non-portable audio systems, and other non-portable systems, while receiving wireless signals from one or more wireless devices, for playback using the non-portable system. Embodiments of the present apparatus are usable to send and receive voice signals, to incoming wireless telephone calls, and to automatically and/or selectively cease playback of certain signals in favor of other signals.

While various embodiments of the present invention have been described with emphasis, it should be understood that within the scope of the appended claims, the present invention might be practiced other than as specifically described herein.

What is claimed is:

1. An apparatus for use communicating signals from a first device to a second device, the apparatus comprising:
a housing configured to removably engage the second device;
a receiver disposed within the housing, wherein the receiver is configured to receive a wireless signal from the first device; and
circuitry disposed within the housing, wherein the circuitry causes playback of the wireless audio signal from the first device using the second device.

2. The apparatus of claim 1, further comprising:
a microphone for receiving voice input from a user; and
a transmitter in communication with the microphone, wherein the transmitter is configured to transmit the voice input to the first device for further wireless transmission, and wherein the circuitry is adapted to cause transmission of the voice input from the microphone to the first device.

3. The apparatus of claim 1, wherein the first device comprises a cellular telephone, a portable computer, a portable audio device, a portable video device, or combinations thereof.

4. The apparatus of claim 1, wherein the second device comprises audio speakers in communication with a vehicle-based audio system, a non-portable audio system, or combinations thereof.

5. The apparatus of claim 4, wherein the housing engages an auxiliary port of the vehicle-based audio system.

6. The apparatus of claim 1, wherein the second device comprises audio speakers and a display apparatus.

7. The apparatus of claim 1, wherein the housing comprises a cylindrical shape or a rectangular shape.

8. The apparatus of claim 1, wherein the circuitry comprises a processor in communication with computer instructions for instructing the processor to convert the wireless signal to a format usable for playback by the second device.

9. The apparatus of claim 2, wherein the circuitry comprises a processor in communication with computer instructions for instructing the processor to convert the voice input to a format usable for receiving, transmitting, or combinations thereof, by the first device.

10. The apparatus of claim 2, further comprising an input member usable to selectively:
provide power to the apparatus, cause playback of the wireless signal using the second device, cease playback of the wireless signal while transmitting the voice input, establish recognition between the apparatus and a wireless device, or combinations thereof.

11. The apparatus of claim 1, wherein the audio circuitry is adapted to automatically cease playback of a first wireless signal when a second wireless signal is received.

12. A method for communicating audio signals from a first device to a second device, the method comprising the steps of:
providing an apparatus in communication with the second device, wherein the apparatus comprises a receiver and circuitry;
receiving, by the receiver, a first wireless signal from the first device;
communicating the first wireless signal from the apparatus to the second device; and
causing playback of the first wireless signal by the second device.

13. The method of claim 12, wherein the apparatus further comprises a microphone and a transmitter, the method further comprising the steps of:
receiving, by the microphone, a voice input; and
communicating the voice input from the apparatus to the first device.

14. The method of claim 12, wherein the step of providing the apparatus in communication with the second device comprises engaging the apparatus with an auxiliary port of a vehicle-based audio system.

15. The method of claim 12, wherein the step of communicating the first wireless signal from the apparatus to the second device comprises converting the first wireless signal to a format usable for playback by the second device.

16. The method of claim 13, wherein the step of communicating the voice input from the apparatus to the first device comprises converting the voice input to a format usable for receipt, transmission, or combinations thereof, by the first device.

17. The method of claim 13, further comprising the step of receiving a second wireless signal from the first device and automatically ceasing playback of the first wireless signal.

18. The method of claim 12, further comprising the step of establishing recognition between the apparatus and the first device.

19. An apparatus for use communicating audio signals from a wireless device to a vehicle-based device, the apparatus comprising:
a housing in removable engagement with the vehicle-based device;
a receiver disposed within the housing, wherein the receiver is in wireless communication with the wireless device for receiving a wireless signal from the first device;
a microphone disposed within the housing for receiving voice input from a user;
a transmitter disposed within the housing in communication with the microphone and in wireless communication with the wireless device, wherein the transmitter is configured to transmit the voice input to the wireless device for further wireless transmission; and
circuitry disposed within the housing, wherein the circuitry is configured to cause playback of the wireless signal from the wireless device using the vehicle-based device and to cause transmission of the voice input from the microphone to the wireless device.

20. The apparatus of claim 19, wherein the circuitry comprises a processor in communication with computer instructions for instructing the processor to convert the wireless signal to a format usable for playback by the second device, to convert the voice input to a format usable for receiving, transmitting, or combinations thereof, by the wireless device, or combinations thereof.

21. The apparatus of claim 19, wherein the circuitry is adapted to automatically cease playback of a first wireless signal when a second wireless signal is received.
